(19) United States
(12) Patent Application Publication
(10) Pub. No.: US 2016/0263561 A1
(43) Pub. Date: Sep. 15, 2016

(54) Cerium-Cobalt Spinel System as ZPGM Composition for DOC Applications

(71) Applicant: Clean Diesel Technologies, Inc., Oxnard, CA (US)

(72) Inventors: Zahra Nazarpoor, Camarillo, CA (US); Stephen J. Golden, Santa Barbara, CA (US)

(73) Assignee: Clean Diesel Technologies, Inc., Oxnard, CA (US)

(21) Appl. No.: 14/657,833

(22) Filed: Mar. 13, 2015

(51) Int. Cl. B01J 23/83; B01J 35/02; B01J 23/00

(52) U.S. Cl. CPC B01J 23/83; B01J 23/005; B01J 35/02

(57) ABSTRACT

Variations of ZPGM catalyst material compositions including cerium-cobalt spinel oxide systems for ZPGM DOC applications are disclosed. The disclosed ZPGM catalyst compositions include CeₓCo₃₋ₓO₄ spinel and effect of adding copper to Ce-Co as CuₓCe₁₋ₓCo₂O₄ spinel systems supported on doped zirconia support oxide, which are produced by the incipient wetness (IW) methodology. ZPGM catalyst compositions are subjected to BET-surface area and XRD analyses to determine the thermal stability and spinel phase formation of supported spinal systems, respectively. DOC performance of ZPGM catalyst compositions is determined under steady state DOC light off test condition to verify/compare oxidation activity of disclosed spinel compositions, desirable and suitable for ZPGM catalyst materials in DOC applications.

### BACKGROUND

1. Field of the Disclosure

This disclosure relates generally to catalyst materials, and more particularly, to variations of catalyst material compositions including Ce-Co spinel systems.

2. Background Information

Diesel engines offer superior fuel efficiency and greenhouse gas reduction potential. However, one of the technical obstacles to their broad implementation is the requirement for a lean nitrogen oxide (NOₓ) exhaust system. Conventional lean NOₓ exhaust systems are expensive to manufacture and are key contributors to the premium pricing associated with diesel engine equipped vehicles. Unlike a conventional gasoline engine exhaust in which equal amounts of oxidants (O₂ and NOₓ) and reductants (CO, H₂, and hydrocarbons) are available, diesel engine exhaust contains excessive O₂ due to combustion occurring at much higher air-to-fuel ratios (>20). This oxygen-rich environment makes the removal of NOₓ much more difficult.

Conventional diesel exhaust systems employ diesel oxidation catalyst (DOC) technology and are referred to as diesel oxidation catalyst (DOC) systems. Typically, DOC systems include a substrate structure upon which promoting oxides are deposited. Bimetallic catalysts, based on platinum group metals (PGM), are then deposited upon the promoting oxides.

Although PGM catalyst materials are effective for toxic emission control and have been commercialized by the emissions control industry, PGM materials are scarce and expensive. This high cost remains a critical factor for wide spread applications of these catalyst materials. Therefore, there is a need to provide a lower cost DOC system exhibiting catalytic properties substantially similar to or better than the catalytic properties exhibited by DOC systems employing PGM catalyst materials.

### SUMMARY

The present disclosure describes Zero-Platinum Group Metals (ZPGM) material compositions including Ce-Co spinel supported on doped zirconia support oxide for DOC applications.

In some embodiments, ZPGM catalyst compositions of Ce-Co spinel at different molar ratios supported on doped zirconia support oxide are produced via incipient wetness (IW) methodology. In other embodiments, ZPGM catalyst compositions of Cu-Ce-Co spinels at different molar ratios and supported on doped zirconia support oxide are produced via IW methodology. In these embodiments, the effect of adding copper (Cu) to Ce-Co spinel system on oxidation performance is analyzed.

In some embodiments, ZPGM powder catalyst compositions of Ce-Co and Cu-Ce-Co spinels are subjected to a BET surface area analysis at plurality of temperatures. In other embodiments, XRD analyses are performed to determine the spinel phase formation and stability of Ce-Co and Cu-Ce-Co spinels at a plurality of temperatures within the range of about 800° C. to about 1000° C.

In some embodiments, DOC performance of ZPGM catalyst compositions, including disclosed Ce-Co and Cu-Ce-Co spinel systems supported on doped zirconia support oxide, is determined with a steady state light off (LO) test. The LO test employs a flow reactor with a DOC gas stream at different temperatures to measure NO, CO and HC conversions. Activity results are compared to demonstrate the performance of ZPGM catalyst compositions for DOC applications.

According to the principles of this present disclosure, test results of ZPGM catalyst compositions exhibiting significant DOC performance can be used in the development of improved ZPGM catalyst systems. The disclosed ZPGM catalyst compositions can provide an essential advantage given the economic factors involved when completely or substantially PGM-free materials are used to manufacture ZPGM catalysts for a plurality of DOC applications.

Numerous other aspects, features, and benefits of the present disclosure may be made apparent from the following detailed description taken together with the drawing figures, which may illustrate the embodiments of the present disclosure, incorporated herein for reference.

### BRIEF DESCRIPTION OF THE DRAWINGS

The present disclosure can be better understood by referring to the following figures. The components in the figures are not necessarily to scale, emphasis instead being place upon illustrating the principles of the disclosure. In the figures, reference numerals designate corresponding parts throughout the different views.

FIG. 1 is a graphical representation illustrating an X-ray diffraction (XRD) phase formation analysis of Ce-Co spinel supported on doped zirconia support oxide and calcined at about 800° C., according to an embodiment.

FIG. 2 is a graphical representation illustrating an XRD phase formation analysis of Cu-Ce-Co spinel deposited onto doped zirconia support oxide and calcined at about 800° C., according to an embodiment.

FIG. 3 is a graphical representation illustrating NO and CO conversions by Ce-Co and Cu-Ce-Co spinel systems supported on doped zirconia support oxide, and operating under steady state DOC light off (LO) test conditions, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### Definitions

As used here, the following terms have the following definitions:

“Platinum group metals (PGM)” refers to platinum, palladium, ruthenium, iridium, osmium, and rhodium.

“Zero-PGM (ZPGM)” refers to a catalyst completely or substantially free of PGM.

“Catalyst” refers to one or more materials that may be of use in the conversion of one or more other materials.

“Calcination” refers to a thermal treatment process applied to solid materials, in presence of air, to bring about a thermal decomposition, phase transition, or removal of a volatile fraction at temperatures below the melting point of the solid materials.

“Incipient wetness (IW)” refers to the process of adding solution of catalytic material to a dry support oxide powder until all pore volume of support oxide is filled out with solution and mixture goes slightly near saturation point.

“Treating, treated, or treatment” refers to drying, firing, heating, evaporating, calcining, or mixtures thereof.

“Spinel” refers to any minerals of the general formulation AB₂O₄ where the A ion and B ion are each selected from mineral oxides, such as, magnesium, iron, zinc, manganese, aluminum, chromium, or copper, among others.

“Support oxide” refers to porous solid oxides, typically mixed metal oxides, which are used to provide a high surface area which aids in oxygen distribution and exposure of catalysts to reactants, such as, NOₓ, CO, and hydrocarbons.

“Doped zirconia” refers to an oxide including zirconium and an amount of dopant from the lanthanide group of elements.

“Diesel oxidation catalyst (DOC)” refers to a device that utilizes a chemical process in order to break down pollutants within the exhaust stream of a diesel engine, turning them into less harmful components.

“Brunauer-Emmett-Teller (BET) surface area analysis” refers to an analytical technique for determining the specific surface area of a powder defined by physical adsorption of a gas on the surface of the solid, and by calculating the amount of adsorbate gas corresponding to a mono-molecular layer on the surface.

“X-ray diffraction (XRD) analysis” refers to a rapid analytical technique for verifying crystalline material structures, including atomic arrangement, crystalline size, and imperfections in order to identify unknown crystalline materials (e.g., minerals, inorganic compounds).

### DESCRIPTION OF THE DISCLOSURE

The present disclosure describes Zero-Platinum Group Metals (ZPGM) material compositions including cerium-cobalt and copper-cerium-cobalt spinel systems supported on doped zirconia support oxide for diesel oxidation catalyst (DOC) applications.

ZPGM Catalyst Samples Composition and Preparation

The disclosed ZPGM material compositions in form of bulk powder are produced from Ce-Co or Cu-Ce-Co spinel compositions. In some embodiments, ZPGM material compositions include Ce-Co spinel compositions with general formula of CeₓCo₃₋ₓO₄, where X=0.2 to 1.5. In other embodiments, ZPGM material compositions include Cu-Ce-Co spinel compositions with general formula CuₓCe₁₋ₓCo₂O₄, where X=0.01 to 0.99.

In some embodiments, Ce-Co or Cu-Ce-Co spinel compositions are deposited onto doped zirconia support oxide via incipient wetness (IW) methodology (described below). In these embodiments, the support oxide selected for Ce-Co and Cu-Ce-Co spinels is doped zirconia support oxide (ZrO₂-10% Pr₆O₁₁).

In some embodiments, the preparation of ZPGM catalyst compositions includes producing a binary or ternary spinel and overlaying the produced spinel onto a support oxide. In these embodiments, producing a binary spinel includes preparing a binary solution of Ce-Co by mixing the appropriate amount of Ce nitrate solution (Ce(NO₃)₃) and Co nitrate solution (Co(NO₃)₂) with water to produce solution at different molar ratios. The disclosed Ce-Co binary spinel composition is illustrated in Table 1, below. Further to these embodiments, the solution of Ce-Co nitrate is added drop-wise on to doped zirconia support oxide via IW methodology. In these embodiments, the mixture of Ce-Co nitrate with the doped zirconia support oxide is dried at about 120° C. overnight and then calcined within a temperature range from about 600° C. to about 1000° C., with a preferred embodiment having the calcination performed at about 800° C. for about 5 hours. The calcined material of Ce-Co binary spinel deposited onto the doped zirconia support oxide is then ground into a fine grain bulk powder.

In other embodiments, producing a ternary spinel includes preparing a ternary solution of Cu-Ce-Co by mixing the appropriate amount of Cu nitrate solution (CuNO₃), Ce nitrate solution (Ce(NO₃)₃), and Co nitrate solution Co(NO₃)₂ with water to produce solution at different molar ratios. The disclosed Cu-Ce-Co ternary spinel compositions are illustrated in Table 1, below. In these embodiments, the solution of Cu-Ce-Co nitrates is added drop-wise onto doped zirconia support oxide via IW methodology. Further to these embodiments, the different mixtures of Cu-Ce-Co nitrate with the doped zirconia support oxide are dried at about 120° C. overnight and then calcined within a temperature range from about 600° C. to about 1000° C., with a preferred embodiment having the calcination performed at about 800° C. for about 5 hours. The calcined materials of Cu-Ce-Co spinels deposited onto the doped zirconia support oxide are then ground into fine grain bulk powders.

TABLE 1
Binary and ternary spinel systems and associated compositions.

| System | Composition |
|---|---|
| Binary | CeCo₂O₄ |
| | Cu_{0.02}Ce_{0.98}Co₂O₄ |
| Ternary | Cu_{0.5}Ce_{0.5}Co₂O₄ |
| | Cu_{0.98}Ce_{0.02}Co₂O₄ |

BET-Surface Area Analysis

In some embodiments, ZPGM powder catalyst compositions of Ce-Co and Cu-Ce-Co spinels are subjected to a Brunauer-Emmett-Teller (BET) surface area analysis at a plurality of temperatures. In these embodiments and prior any measurement, the ZPGM powder catalyst composition samples are degassed to remove water and other contaminants from the powder catalyst composition samples before the surface area can be accurately measured. Further to these embodiments, the bulk powder catalyst composition samples are degassed in a vacuum environment at a plurality of temperatures. In some embodiments, the preferred temperature for degassing the bulk powder catalyst composition samples is the highest temperature that will not damage the structure of the powder catalyst composition samples. In these embodiments, the highest temperature that will not damage the structure of the powder catalyst composition samples is chosen to shorten the degassing time. Further to these embodiments, a minimum of about 0.5 g of catalyst composition sample is required for the BET to successfully determine the surface area. Powder catalyst composition samples are placed in glass cells to be degassed and analyzed by the BET-surface area measurement analyzer. An example of a BET surface analyzer is the Horiba SA-9600 available from Horiba Instruments, Inc. of Irvine, Calif., USA.

X-ray Diffraction Analysis for Ce-Co Binary and Cu-Ce-Co Ternary Spinel Samples

According to some embodiments, X-ray diffraction (XRD) analyses are performed to analyze/measure the spinel phase formation and phase stability of the ZPGM catalyst compositions of Ce-Co binary and Cu-Ce-Co ternary spinel systems. In these embodiments, the effect of calcination (firing) temperature in the phase stability of Ce-Co binary and Cu-Ce-Co ternary spinel phases is also analyzed by using XRD analyses.

In some embodiments, XRD patterns are measured on a powder diffractometer using Cu Ka radiation in the 2-theta range of about 15°-100° with a step size of about 0.02° and a dwell time of about 1 second. In these embodiments, the tube voltage and current are set to about 40 kV and about 30 rnA, respectively. The resulting diffraction patterns are analyzed using the International Center for Diffraction Data (ICDD) database to identify phase formation. Examples of powder diffractometer include the MiniFlex™ powder diffractometer available from Rigaku® of The Woodlands, Tex.

Steady State DOC Light Off Test

In some embodiments, DOC light off (LO) test methodology is applied to Ce-Co and Cu-Ce-Co spinel systems supported on doped zirconia support oxide. In these embodiments, the LO test is performed employing a flow reactor and increasing temperatures from about 100° C. to about 400° C. to measure the CO, HC and NO conversions. Further to these embodiments, the space velocity (SV) is set at about 54,000 h⁻¹. In these embodiments, the gas feed employed for the test is a standard DOC gas composition. The standard DOC gas composition includes about 150 ppm of NO, about 1,500 ppm of CO, about 4% of CO₂, about 4% of H₂O, about 14% of O₂, and about 430 ppm of C₃H₆.

Further to these embodiments, the results from LO test are compared to determine the influence of Ce-Co binary and Cu-Ce-Co ternary spinel systems on DOC performance.

Ce-Co and Cu-Ce-Co Spinel Phase Formation and Stability

The BET-surface area test results of Ce-Co and Cu-Ce-Co spinels supported on doped zirconia support oxide and after calcination at about 800° C. are illustrated in Table 2, below. Doped zirconia support oxide has a surface area of about 56.7 m²/g prior to deposition of Ce-Co or Cu-Ce-Co spinel. Therefore, according to Table 2, the surface area of the doped zirconia support oxide decreases after IW methodology is employed to deposit the spinel compositions onto the doped zirconia support oxide.

The surface area of CeCo₂O₄ spinel deposited onto the doped zirconia exhibits the smallest reduction; with a BET-surface area of about 40.3 m²/g. However, the surface area of the supported spinel compositions is lowered when copper (Cu) is added as a dopant agent; thereby presenting a BET-surface area value of about 38.4 m²/g, 19.6 m²/g, and 18.6 m²/g for Cu_{0.02}Ce_{0.98}Co₂O₄, Cu_{0.5}Ce_{0.5}Co₂O₄, and Cu_{0.98}Ce_{0.02}Co₂O₄, respectively. These results verify that the addition of Cu unfavorably affects the BET-surface area of CuₓCe₁₋ₓCo₂O₄ spinel compositions.

TABLE 2
BET-surface area results of specific ZPGM bulk powder compositions.

| Composition | BET (m²/g) |
|---|---|
| CeCo₂O₄/doped zirconia | 40.3 |
| Cu_{0.02}Ce_{0.98}Co₂O₄/doped zirconia | 38.4 |
| Cu_{0.5}Ce_{0.5}Co₂O₄/doped zirconia | 19.6 |
| Cu_{0.98}Ce_{0.02}Co₂O₄/doped zirconia | 18.6 |

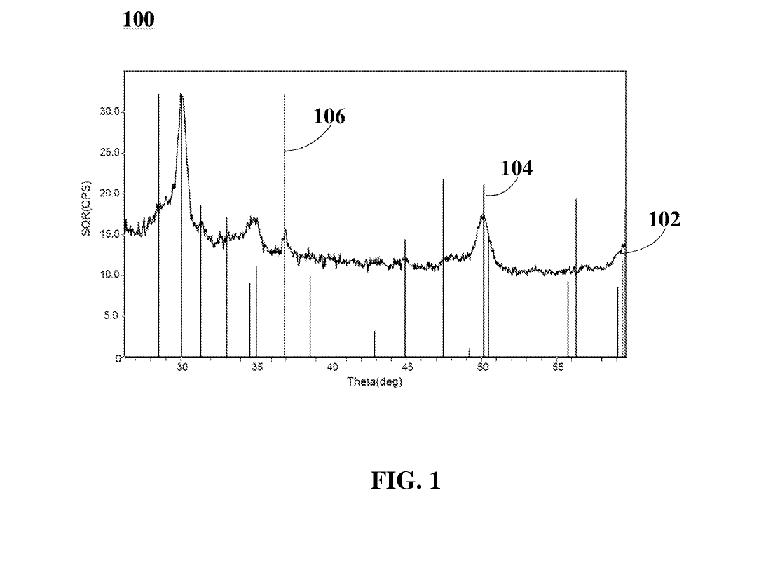

FIG. 1 is a graphical representation illustrating an X-ray diffraction (XRD) phase formation analysis of Ce-Co spinel supported on doped zirconia support oxide and calcined at about 800° C., according to an embodiment.

In FIG. 1, XRD analysis 100 includes XRD spectrum 102, solid line 104, and solid line 106. XRD spectrum 102 illustrates bulk powder CeCo₂O₄ spinel supported on doped zirconia support oxide and calcined at a temperature of about 800° C. In some embodiments and after calcination, a zirconia (ZrO₂) phase arranged in a tetragonal structure is produced, as illustrated by solid line 104. In these embodiments, zirconia is the main phase within the bulk powder CeCo₂O₄ spinel supported on doped zirconia support oxide. Further to these embodiments, a CeCo₂O₄ phase arranged in a cubic structure is produced, as illustrated by solid line 106.

In other embodiments and after calcination at about 1000° C. (not shown in FIG. 1), a zirconia phase arranged in a tetragonal structure is produced. In these embodiments, a CeCo₂O₄ spinel phase is also produced.

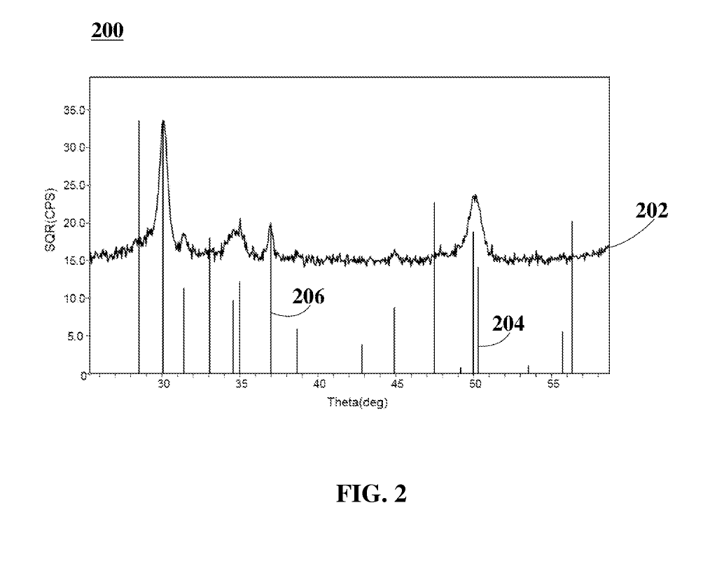

FIG. 2 is a graphical representation illustrating an XRD phase formation analysis of Cu-Ce-Co spinel deposited onto doped zirconia support oxide and calcined at about 800° C., according to an embodiment.

In FIG. 2, XRD analysis 200 includes XRD spectrum 202, solid line 204, and solid line 206. XRD spectrum 202 illustrates bulk powder Cu_{0.5}Ce_{0.5}Co₂O₄ spinel supported on doped zirconia support oxide and calcined at a temperature of about 800° C. In some embodiments and after calcination, a zirconia (ZrO₂) phase arranged in a tetragonal structure is produced, as illustrated by solid line 204. In these embodiments, a Cu_{0.5}Ce_{0.5}Co₂O₄ ternary spinel phase arranged in a cubic structure is also produced, as illustrated by solid line 206.

Analysis of Influence of Type of Spinel on DOC Performance

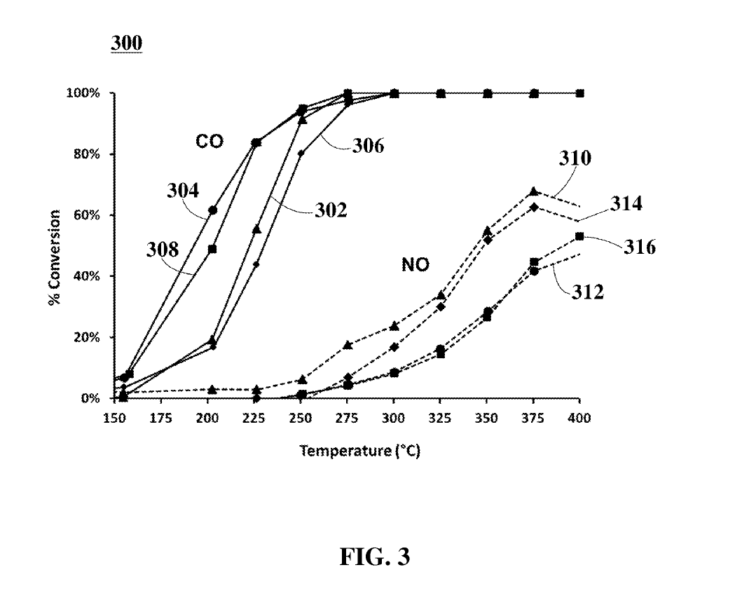

FIG. 3 is a graphical representation illustrating NO and CO conversions by Ce-Co and Cu-Ce-Co spinel systems supported on doped zirconia support oxide, and operating under steady state DOC light off (LO) test conditions, according to an embodiment.

In some embodiments, conversion curve 302 (solid line with triangles), conversion curve 304 (solid line with circles), conversion curve 306 (solid line with rhombuses), and conversion curve 308 (solid line with squares) illustrate a CO conversion comparison of CeCo₂O₄, Cu_{0.5}Ce_{0.5}Co₂O₄, Cu_{0.2}Ce_{0.98}Co₂O₄, and Cu_{0.98}Ce_{0.02}Co₂O₄ supported on doped zirconia support oxide, respectively.

In these embodiments, conversion curve 310 (solid line with triangles), conversion curve 312 (solid line with circles), conversion curve 314 (solid line with rhombuses), and conversion curve 316 (solid line with squares) illustrate a NO conversion comparison of CeCo₂O₄, Cu_{0.5}Ce_{0.5}Co₂O₄, Cu_{0.02}Ce_{0.98}Co₂O₄, and Cu_{0.98}Ce_{0.02}Co₂O₄ supported on doped zirconia support oxide, respectively.

Further to these embodiments, all ZPGM catalyst compositions exhibit a high catalytic activity in CO oxidation. This high catalytic activity in CO oxidation indicates substantially complete CO conversion at temperatures below 275° C. Still further to these embodiments, among Ce-Co and Cu-Ce-Co spinel systems, Cu_{0.5}Ce_{0.5}Co₂O₄ (conversion curve 304) exhibits the highest CO conversion when compared to the other disclosed spinel systems.

In some embodiments, NO oxidation activity dramatically increases after CO oxidation is substantially completed, at about 275° C. In these embodiments, the CeCo₂O₄ binary spinel system (conversion curve 310) exhibits higher NO oxidation activity than the Cu-Ce-Co ternary spinel systems. Further to these embodiments, the temperature for maximum NO conversion occurs at about 375° C., with a NO conversion of about 67.9% for CeCo₂O₄ binary spinel. Still further to these embodiments, the effect of adding Cu to Ce-Co spinel decreases NO oxidation activity. The amount of the addition of Cu to the spinel results in an associated decrease of NO oxidation activity as follows: CeCo₂O₄>Cu_{0.02}Ce_{0.98}Co₂O₄>Cu_{0.5}Ce_{0.5}Co₂O₄>Cu_{0.98}Ce_{0.02}Co₂O₄.

ZPGM catalyst compositions of Ce-Co spinel supported on doped zirconia or Cu-Ce-Co spinels with small amount of Cu dopant supported on doped zirconia can be employed in ZPGM catalyst for a plurality of DOC applications. Using the aforementioned ZPGM catalyst material compositions results in higher catalytic activity within DOC products.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A catalytic system, comprising:
a substrate;
a washcoat suitable for deposition on the substrate; and
an overcoat suitable for deposition on the substrate, the overcoat comprising a catalyst comprising a spinel having the general formula CeₓCo₃₋ₓCo₄, where x=0.2 to 1.5.

2. The system of claim 1, wherein the spinel has the formula CeCo₂O₄.

3. The system of claim 1, wherein the oxide powder comprising Ce_{0.75}Zr_{0.5}O₂.

4. The system of claim 1, wherein CO is oxidized by the catalyst.

5. The system of claim 1, wherein hydrocarbons are oxidized by the catalyst.

6. The system of claim 1, wherein NO oxidation occurs at about 275° C.

7. The system of claim 1, wherein NO oxidation occurs between about 275° C. and about 375° C.

8. The system of claim 1, wherein NO conversion is greater than 60%.

9. The system of claim 1, wherein NO conversion is greater than 67%.

10. A catalyst, comprising: a spinel having the general formula CeₓCo₃₋ₓO₄, where x=0.2 to 1.5.

11. The catalyst of claim 10, wherein the spinel has the formula CeCo₂O₄.

12. The catalyst of claim 10, wherein the oxide powder comprising Ce_{0.75}Zr_{0.5}O₂.

13. The catalyst of claim 10, wherein CO is oxidized by the catalyst.

14. The catalyst of claim 10, wherein hydrocarbons are oxidized by the catalyst.

15. The catalyst of claim 10, wherein NO oxidation occurs at about 275° C.

16. The catalyst of claim 10, wherein NO oxidation occurs between about 275° C. and about 375° C.

17. The catalyst of claim 10, wherein NO conversion is greater than 60%.

18. The catalyst of claim 10, wherein NO conversion is greater than 67%.

19. A catalyst, comprising: a spinel having the general formula CuₓCe₁₋ₓCo₂O₄, where x=0.01 to 0.99.

20. The catalyst of claim 19, wherein the spinel has the formula Cu_{0.5}Ce_{0.5}Co₂O₄.

21. The catalyst of claim 19, wherein the oxide powder comprising Ce_{0.75}Zr_{0.5}O₂.

22. The catalyst of claim 19, wherein CO is oxidized by the catalyst.

23. The catalyst of claim 1, wherein hydrocarbons are oxidized by the catalyst.

24. The catalyst of claim 19, wherein CO oxidation occurs at about 275° C.

25. The catalyst of claim 19, wherein NO conversion is greater than 90%.
